(19) United States
(12) Patent Application Publication
(10) Pub. No.: US 2012/0002859 A1
(43) Pub. Date: Jan. 5, 2012

(54) MAGNETIC RESONANCE PARTIALLY PARALLEL IMAGING (PPI) WITH MOTION CORRECTED COIL SENSITIVITIES

(75) Inventors: Feng Huang, Gainesville, FL (US); Wei Lin, Gainesville, FL (US); Yu Li, Gainesville, FL (US)

(73) Assignee: KONINKLIJKE PHILIPS ELECTRONICS N.V., EINDHOVEN (NL)

(21) Appl. No.: 13/254,468

(22) PCT Filed: Feb. 9, 2010
(86) PCT No.: PCT/IB10/50592

§ 371 Date: Sep. 2, 2011

Related U.S. Application Data
(60) Provisional application No. 61/163,265, filed on Mar. 25, 2009.
(60) Provisional application No. 61/248,979, filed on Oct. 6, 2009.

(51) Int. Cl. G06K 9/00

(52) U.S. Cl. 382/131

(57) ABSTRACT

Magnetic resonance (MR) imaging performed in cooperation with an MR scanner (10) uses a method comprising: (i) acquiring sensitivity maps (34) for a plurality of radio frequency coils using a MR pre scan (50) performed by the MR scanner; (ii) acquiring an MR imaging data set (38) using the plurality of radio frequency coils and the MR scanner; and (iii) reconstructing (62, 78) the MR imaging data set using partially parallel image reconstruction employing the sensitivity maps and a correction for subject motion between the acquiring (i) and the acquiring (ii).

The following relates to the medical arts, magnetic resonance arts, and related arts.

Partially parallel imaging techniques such as SENSE utilizes multiple radio frequency coils to provide additional imaging data that is used to reduce imaging time or otherwise enhance imaging efficacy. In SENSE, for example, the number of acquired phase-encode lines is reduced and the resulting incomplete k-space data set is compensated using data acquired simultaneously by a plurality of coils having different coil sensitivities. SENSE and other partially parallel imaging techniques rely upon accurate coil sensitivity maps.

In one approach, a low resolution pre-scan of the subject is acquired and the coil sensitivity maps are derived therefrom. This allows for generation of relatively low-noise coil sensitivity maps with suppressed artifacts, which are then used in partially parallel image reconstruction of subsequently acquired imaging data. A disadvantage of such pre-scan-based techniques is that if the subject moves between the pre-scan and the imaging data acquisition, then this can cause misalignment between the sensitivity maps and the imaging data resulting in errors or artifacts in the partially parallel reconstruction.

In another approach, auto-calibration signal (ACS) lines are interspersed with or otherwise acquired during the imaging data acquisition, and the ACS data are used to generate the sensitivity maps for partially parallel image reconstruction. The acquisition of ACS lines for generating the coil sensitivity maps involves a trade-off between the acceleration factor of the partially parallel image reconstruction and the accuracy of the sensitivity maps. Acquiring more ACS lines provides more accurate sensitivity maps but at the cost of a lower acceleration factor. Acquiring fewer ACS lines provides more acceleration but less accurate sensitivity maps. Typically, between about 24 ACS lines and 64 ACS lines are acquired. The resulting coil sensitivity maps sometimes suffer from noise or other artifacts such as Gibbs rings.

The following provides new and improved apparatuses and methods which overcome the above-referenced problems and others.

In accordance with one disclosed aspect, a method comprises: acquiring initial sensitivity maps for a plurality of radio frequency coils using a magnetic resonance (MR) pre-scan of a subject; acquiring an MR imaging data set for the subject using the plurality of radio frequency coils; correcting the initial sensitivity maps for subject motion to generate corrected sensitivity maps for the plurality of radio frequency coils; and reconstructing the MR imaging data set using partially parallel image reconstruction employing the corrected sensitivity maps to generate a corrected image of the subject.

In accordance with another disclosed aspect, a method comprises: (i) acquiring sensitivity maps for a plurality of radio frequency coils using a magnetic resonance (MR) pre-scan of a subject; (ii) acquiring an MR imaging data set for the subject using the plurality of radio frequency coils; and (iii) reconstructing the MR imaging data set using partially parallel image reconstruction employing the sensitivity maps corrected for subject motion between the acquiring (i) and the acquiring (ii).

In accordance with another disclosed aspect, a digital storage medium stores instructions executable by a digital processor to reconstruct a magnetic resonance (MR) imaging data set using a method as set forth in any one of the two immediately preceding paragraphs.

In accordance with another disclosed aspect, an apparatus comprises a digital processor configured to perform magnetic resonance (MR) imaging in cooperation with an MR scanner using a method comprising: (i) acquiring sensitivity maps for a plurality of radio frequency coils using an MR pre-scan performed by the MR scanner; (ii) acquiring an MR imaging data set using the plurality of radio frequency coils and the MR scanner; and (iii) reconstructing the MR imaging data set using partially parallel image reconstruction employing the sensitivity maps and a correction for subject motion between the acquiring (i) and the acquiring (ii). In some such embodiments, the apparatus further comprises said MR scanner.

One advantage resides in providing accurate sensitivity maps without concomitant reduction in partially parallel imaging acceleration factor.

Another advantage resides in reduced motion artifacts in partially parallel imaging.

Another advantage resides in partially parallel imaging with enhanced acceleration factor.

Further advantages will be appreciated to those of ordinary skill in the art upon reading and understand the following detailed description.

The drawings are only for purposes of illustrating the preferred embodiments, and are not to be construed as limiting the invention.

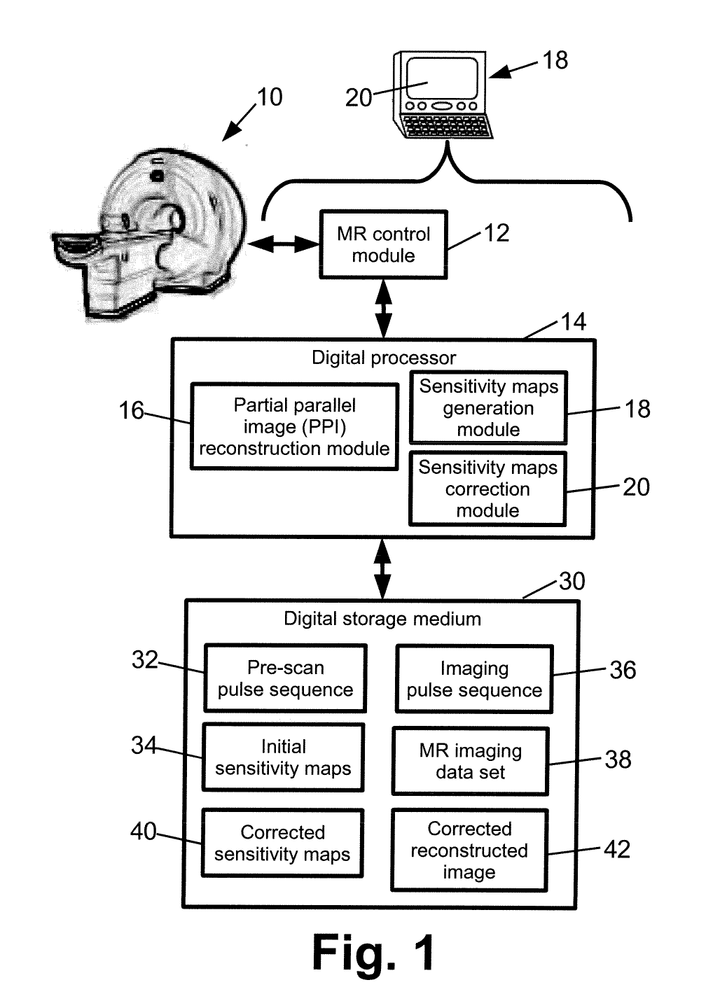

FIG. 1 diagrammatically shows a magnetic resonance imaging system configured to perform partially parallel imaging (PPI).

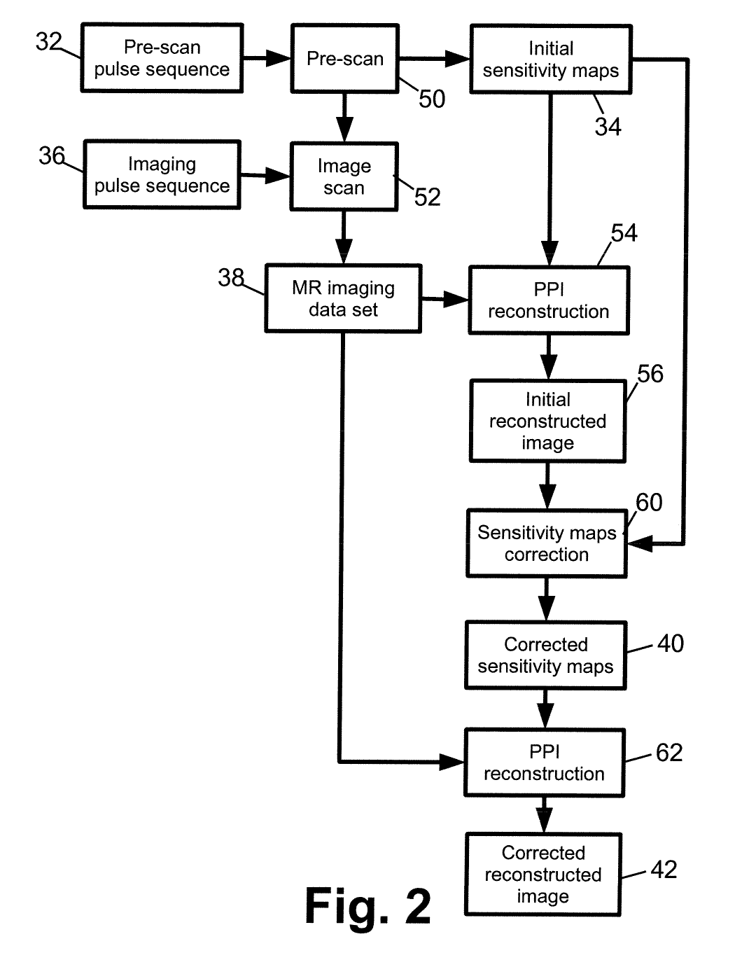

FIG. 2 diagrammatically illustrates PPI performed using the system of FIG. 1 and including motion correction of coil sensitivity maps.

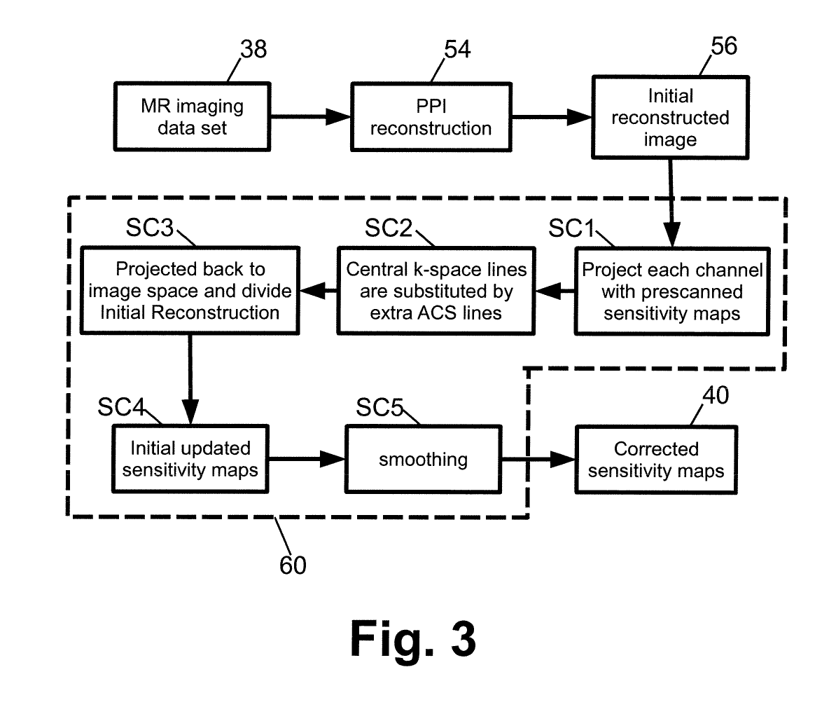

FIG. 3 diagrammatically shows one approach for coil sensitivity maps correction that is suitably used in the PPI of FIG. 2.

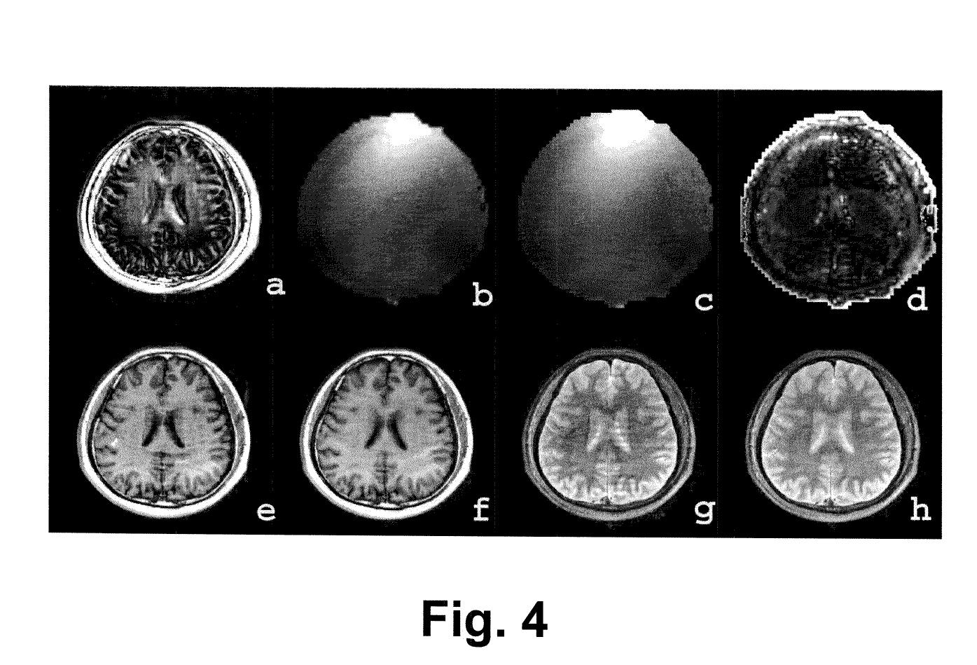

FIG. 4 shows images generated in in vivo experiments disclosed herein.

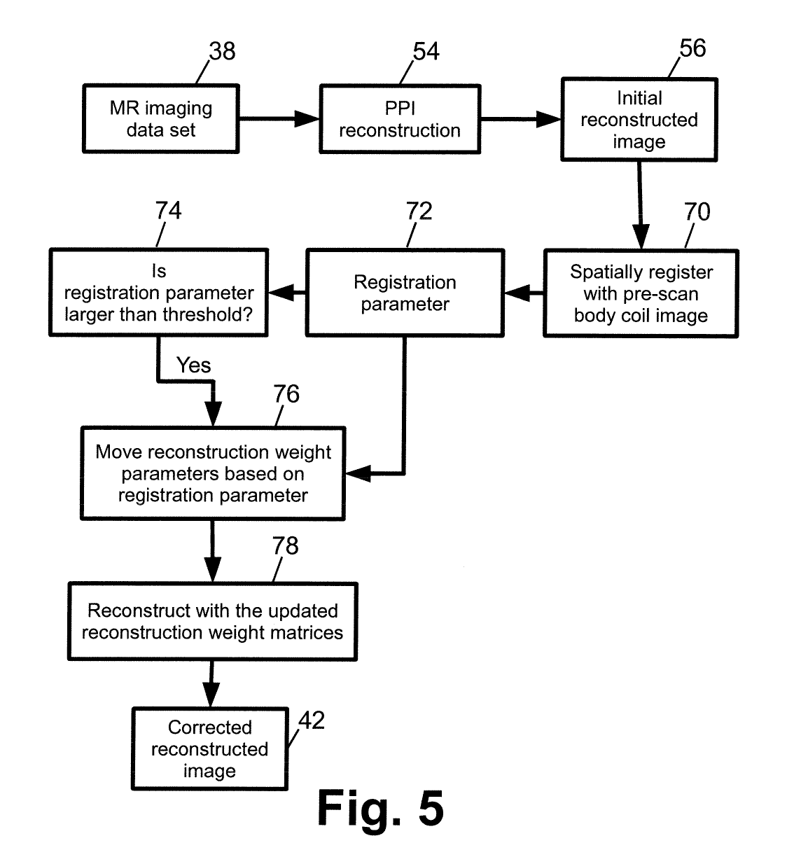

FIGS. 5-8 illustrate an alternative motion correction approach.

With reference to FIG. 1, an imaging system includes a magnetic resonance (MR) scanner 10, such as an illustrated Achieva™ magnetic resonance scanner (available from Koninklijke Philips Electronics N.V., Eindhoven, The Netherlands), or an Intera™ or Panorama™ MR scanner (both also available from Koninklijke Philips Electronics N.V.), or another commercially available MR scanner, or a non-commercial MR scanner, or so forth. In a typical embodiment, the MR scanner includes internal components (not illustrated) such as a superconducting or resistive main magnet generating a static (B₀) magnetic field, sets of magnetic field gradient coil windings for superimposing selected magnetic field gradients on the static magnetic field, a radio frequency excitation system for generating a radiofrequency (B₁) field at a frequency selected to excite magnetic resonance (typically ¹H magnetic resonance, although excitation of another magnetic resonance nuclei or multiple nuclei is also contemplated), and a radio frequency receive system including a plurality of radio frequency receive coils operating independently to define a plurality of radio frequency receive channels for detecting magnetic resonance signals emitted from the subject.

The magnetic resonance scanner 10 is controlled by a magnetic resonance control module 12 to execute a magnetic resonance imaging scan sequence that defines the magnetic resonance excitation, spatial encoding typically generated by magnetic field gradients, and magnetic resonance signal readout concurrently using the plurality of receive channels in a partially parallel imaging (PPI) receive mode. A digital processor 14 is programmed to embody a partially parallel imaging (PPI) reconstruction module 16 to implement a PPI reconstruction such as SENSE, GRAPPA, SMASH, PILS, or so forth. The digital processor 14 is also programmed to embody a sensitivity maps generation module 18 that generates coil sensitivity maps for use in the PPI reconstruction, and a sensitivity maps correction module 20 that corrects the sensitivity maps for subject motion. A digital storage medium 30 in operative communication with the digital processor 14 stores a pre-scan pulse sequence 32 for implementation by the MR scanner 10 to acquire the initial sensitivity maps, and stores acquired initial sensitivity maps 34. The digital storage medium 30 also stores an imaging pulse sequence 36 for implementation by the MR scanner 10 to acquire a magnetic resonance (MR) imaging data set of the subject using PPI, and stores the acquired MR imaging data set 38. Still further, the digital storage medium 30 stores corrected coil sensitivity maps 40 generated from the initial sensitivity maps 34 by the sensitivity maps correction module 20, and also stores a corrected reconstructed image 42 generated from the MR imaging data set 38 and the corrected sensitivity maps 40 by the PPI reconstruction module 16. In the illustrated embodiment, the components 12, 14, 30 are embodied by a computer 18 that also includes a display 20 for displaying the corrected reconstructed image. Alternatively, the components 12, 14, 30 may be embodied by dedicated digital processors, application-specific integrated circuitry (ASIC), or a combination thereof.

With continuing reference to FIG. 1 and with further reference to FIG. 2, in a suitable approach for PPI with motion-corrected sensitivity maps, the initial coil sensitivity maps 34 are generated by a pre-scan 50 implemented by the MR scanner 10 using the pre-scan pulse sequence 32. Subsequently, an image scan 52 is performed by the MR scanner 10 implementing the imaging pulse sequence 36 to generate the MR imaging data set 38. The PPI reconstruction module 16 reconstructs the MR imaging data set 38 using the initial coil sensitivity maps 34 in a PPI reconstruction operation 54 (for example, SENSE using the pre-scanned initial sensitivity maps 34) to generate an initial reconstructed image 56, which however may be flawed due to subject motion that may have occurred during the time interval between the pre-scan 50 and the image scan 52. That time interval may in general be anywhere from a few seconds to a few minutes, a few tens of minutes, or longer. Thus, the initial reconstructed image 56 may include artifacts due to motion.

To correct for this possible imaging flaw, the sensitivity maps correction module 20 performs a sensitivity maps correction 60 that corrects the initial sensitivity maps 34 for any spatial misregistration between the initial sensitivity maps 34 and the initial reconstructed image 56. In one suitable approach, the correction 60 is performed in image space using a suitable spatial registration technique such as maximizing a correlation function between one slice of the three dimensional pre-scanned low resolution image and the initial reconstructed image 56. (See FIG. 5 herein). In some embodiments, the spatial registration is performed in two-dimensions to correct two-dimensional motion. In other embodiments, if the motion along the third dimension is serious then the spatial registration of the pre-scanned low resolution image and the two-dimensional initial reconstruction image is performed in three-dimensions—in other words, the planar image is spatially registered in the three-dimensional space of the initial coil sensitivity maps.

With continuing reference to FIGS. 1 and 2 and with brief reference to FIG. 3, in another sensitivity map correction approach, the imaging sequence 36 employed to acquire the MR imaging data set 38 (that is, the partially acquired k-space data) includes acquisition of one or a few (for example, no more than five) auto-calibration signal (ACS) lines that are interspersed with or otherwise acquired during the imaging data acquisition 52. As a result, the one or more ACS lines are acquired substantially concurrently with the MR imaging data set 38, so that subject motion is not present between acquisition of the one or more ACS lines and the MR imaging data set 38. The ACS lines are then compared with or otherwise used to correct the initial sensitivity maps 34 for subject motion. In one approach, the correction comprises: forward-projecting in an operation SC1 the initial reconstructed image 56 of the subject adjusted by the initial sensitivity maps 34, for example by pixel-wise multiplication of the reconstructed image and the sensitivity map, to generate a corresponding plurality of forward-projected subject image data sets; substituting in an operation SC2 the ACS k-space lines in the plurality of forward-projected subject image data sets; and generating the updated or corrected sensitivity maps 40 based on the forward-projected subject image data sets with substituted ACS k-space lines, for example by re-reconstructing the forward-projected subject image data sets and normalizing the re-reconstructed images by the initial reconstructed image in an operation SC3 to generate initial updated sensitivity maps SC4, and performing L₂-norm smoothing, L₁-norm smoothing, or another smoothing process SC5 to generate the updated or corrected sensitivity maps 40.

With returning reference to FIGS. 1 and 2, the corrected sensitivity maps 40 are used by the PPI reconstruction processor 16 in a second, corrected PPI reconstruction 62 of the MR imaging data set to generate the corrected reconstructed image 42. Optionally, the corrected reconstructed image 42 is used in a further coil sensitivity maps correction operation so that the coil sensitivity maps are iteratively corrected to remove subject motion.

Some illustrative examples and further disclosure is next provided.

If there is motion between pre-scan 50 and the target acquisition 52, then serious aliasing artifacts may occur because of the misregistered sensitivity maps 34. It is disclosed herein that the misregistration can be corrected with a few extra auto-calibration signal (ACS) lines, such as three ACS lines in the illustrative examples. The quality of the reconstructed image 42 is significantly improved with the updated sensitivity maps 40. Said another way, to reduce the misregistration error while taking advantage of the pre-scan approach, it is disclosed herein to add a small number of (for example, between one and five) auto-calibration signal (ACS) lines to the target acquisition in order to correct the misregistered sensitivity maps 34. In vivo experiments disclosed herein using as few as three ACS lines for sensitivity map correction resulted in significant improvement in the subsequent SENSE reconstruction.

In a correction approach disclosed herein, an initial SENSE reconstruction (initial reconstructed image 56) is generated using the original sensitivity maps Sᵢ 34 from the data generated by the pre-scan 50. Artifacts caused by misregistration can be detected using the normalized mutual information (see, for example, Guiasu, Silviu (1977), Information Theory with Applications, McGraw-Hill, New York) between the resulting image 56 and the low-resolution pre-scanned body coil image. If misregistration is detected, then in operation SC1 of FIG. 3 the initial SENSE image 56 is projected back to k-space for each individual coil (by multiplying the original sensitivity maps). Then, in operation SC2 the acquired lines (including ACS) are used to replace the reconstructed k-space lines at the corresponding locations. In operation SC3, with the updated individual coil images from the updated full k-space data, corrected sensitivity maps SC4 can be generated as follows:

$${S}_{i}^{new} = {I}_{i} / ( {\sum }_{j} {I}_{j} {S}_{j}^{*} ) ,$$

where * denotes complex conjugate. Due to the noise and artifacts in the initial SENSE reconstruction, a smoothing constraint (operation SC5) is applied to the sensitivity maps during re-calculation. Due to the slow spatial variation of sensitivity maps, most of their information lies near center of k-space. Therefore as few as three ACS lines are sufficient to correct the sensitivity maps for most applications.

Some in vivo experiments were performed as follows. Brain data sets were acquired on a 3.0T Achieva scanner (Philips, Best, Netherlands), using an 8-channel head coil (Invivo, Gainesville, Fla.). With the same field-of-view (FOV=230×230 mm²), pre-scan data for sensitivity maps, with matrix size of 64×64, and high resolution data, with matrix size of 256×256, were acquired. Before the high resolution data were acquired, the volunteer moved his head which introduced a misregistration between the data sets. Two sets of high resolution data were collected. An inversion recovery (IR) sequence, with TR/TE=2000/20 ms, was used for both data sets. Two different inversion times were used to separately suppress gray matter (TI=800 ms) or fat (TI=180 ms). The TI=800 ms IR sequence was used to acquire the pre-scan data. Phase encoding direction was anterior-posterior. The fully acquired data was artificially under-sampled at R=4, including three additional ACS lines, to simulate the partially parallel acquisition. The net acceleration factor was 3.8. The full k-space data set was used to generate the reference image for the calculation of root mean square error (RMSE). Minimization of L₂ norm is used as the constraint term when smoothing the sensitivity maps. One extra SENSE reconstruction was processed with the updated sensitivity maps.

With reference to FIG. 4, some results of these in vivo experiments are shown. FIG. 4 image (a) is the difference between body coil image and the target image, which demonstrates the translation. The white dashed and black solid arrows show the right edge of body coil image and the target image respectively. FIG. 4 image (b) gives the sensitivity map of channel 1 calculated from the pre-scan data (corresponding to the initial sensitivity map 34). FIG. 4 image (c) gives the updated sensitivity map of channel 1 using the method disclosed herein (corresponding to the corrected sensitivity map 40). The difference between FIG. 4 images (b) and (c) is shown as FIG. 4 image (d). With the use of the updated sensitivity maps, the RMSE in reconstruction were reduced from 8.9% as shown in FIG. 4 image (e) and 10.4% as shown in FIG. 4 image (g) to 4.9% as shown in FIG. 4 image (f) and 6.3% as shown in FIG. 4 image (h).

These in vivo experiments demonstrate that with as few as 3 additional ACS lines, the image quality can be efficiently improved with the corrected sensitivity maps 40. By taking advantage of the pre-scan 50, the disclosed approach can achieve a higher net acceleration factor than in-line calibration techniques and the intensity homogeneity correction is enabled. The disclosed approach employs only one additional SENSE reconstruction 62 with the updated sensitivity maps 40. Further iterations can optionally be performed, although in the in vivo experiments further iterations did not significantly improve image quality.

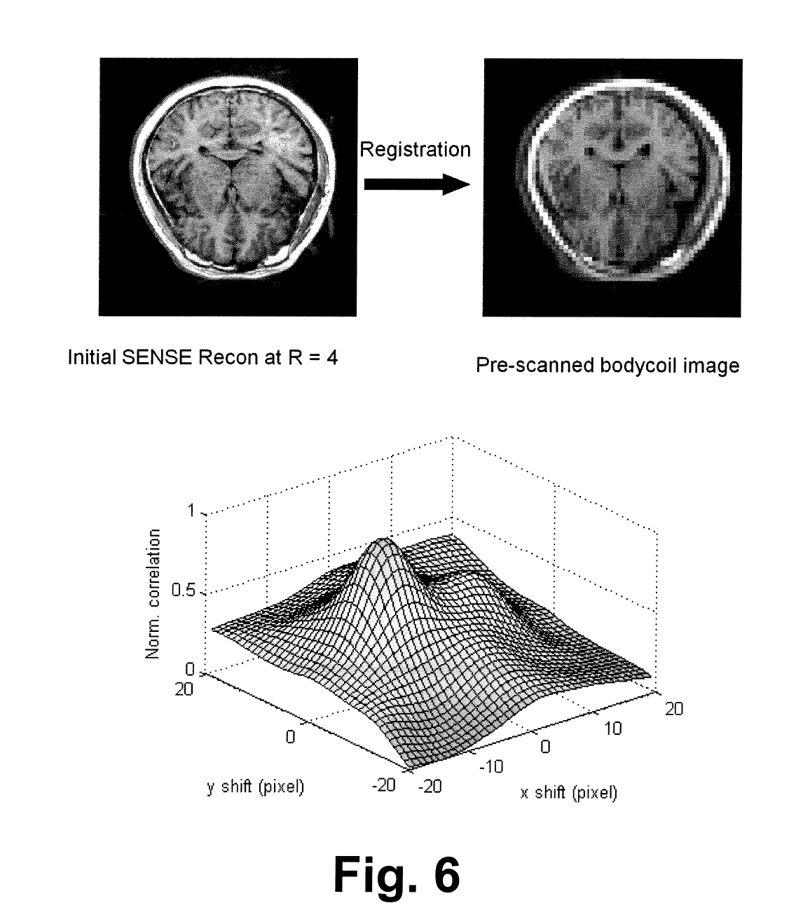

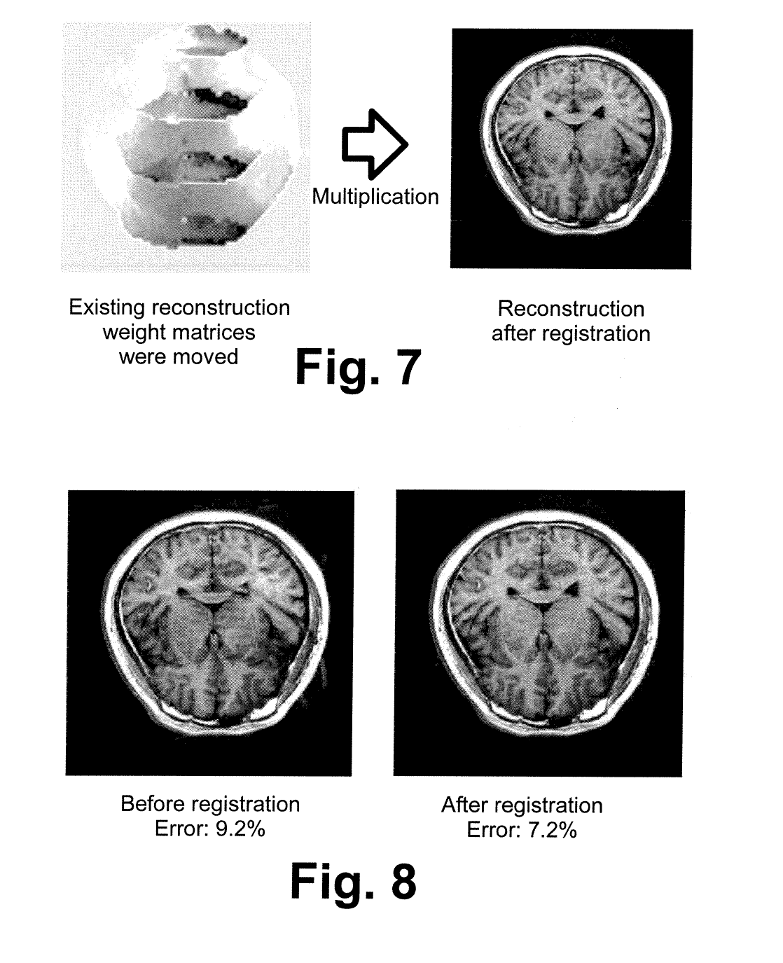

With reference to FIGS. 5-8, another approach for correcting the initial sensitivity maps in order to provide an improved image reconstruction is set forth. Regular SENSE reconstruction 54 is first performed using the initial sensitivity maps 34 to generate the initial reconstructed image 56. In an operation 70, the initial reconstruction and a pre-scan body coil image are registered to calculate the registration parameter 72. This registration typically takes substantially less than one second. FIG. 6 shows the initial SENSE reconstructed image (upper left) and the pre-scan body coil image (upper right), while the surface plotted at bottom of FIG. 6 shows the image correlation as a function of x-pixel and y-pixel shift. The peak of this surface indicates the registration parameter providing best image correlation (that is, best image registration). In a decision 74, if the registration parameter is larger than a threshold then the reconstruction weight matrices (which is already available) are moved in a correction operation 76 based on the calculated registration parameter 72, and the image is reconstructed in an operation 78 using the updated reconstruction weight matrices to generate the corrected reconstructed image 42. FIG. 7 left-hand side illustrates the moved existing weight parameters, while FIG. 7 right-hand side shows the reconstructed image after registration. FIG. 8 compares the “before” and “after” images before and after the registration-based sensitivity map correction. The error is seen to improve from 9.2% down to 7.2% with the registration.

This application has described one or more preferred embodiments. Modifications and alterations may occur to others upon reading and understanding the preceding detailed description. It is intended that the application be construed as including all such modifications and alterations insofar as they come within the scope of the appended claims or the equivalents thereof.

1. A method comprising:
acquiring initial sensitivity maps for a plurality of radio frequency coils using a magnetic resonance (MR) pre-scan of a subject;
acquiring an MR imaging data set for the subject using the plurality of radio frequency coils;
correcting the initial sensitivity maps for subject motion to generate corrected sensitivity maps for the plurality of radio frequency coils; and
reconstructing the MR imaging data set using partially parallel image reconstruction employing the corrected sensitivity maps to generate a corrected image of the subject.

2. The method as set forth in claim 1, wherein the correcting comprises:
reconstructing the MR imaging data set using partially parallel image reconstruction employing the initial sensitivity maps to generate an initial image of the subject; and
compensating the initial sensitivity maps for subject motion based on a comparison of the initial sensitivity maps and the initial image of the subject to generate the corrected sensitivity maps.

3. The method as set forth in claim 2, wherein the compensating comprises:
spatially registering the initial image of the subject with a slice of a pre-scanned image acquired during acquisition of the initial sensitivity maps.

4. The method as set forth in claim 3, wherein the motion is three dimensional and the initial image of the subject is two-dimensional, and the spatial registering is performed in three-dimensions.

5. The method as set forth in claim 3, wherein the compensating further includes moving reconstruction weight matrices based on the spatial registering.

6. The method as set forth in claim 2, wherein the acquiring an MR imaging data set includes acquiring one or more auto-calibration signal (ACS) k-space lines with the MR imaging data set, and the compensating uses the ACS k-space lines in the comparison of the initial sensitivity maps and the initial image of the subject to generate the corrected sensitivity maps.

7. The method as set forth in claim 6, wherein the compensating comprises:
forward-projecting the initial image of the subject adjusted by the initial sensitivity maps to generate a plurality of forward-projected subject image data sets;
substituting the ACS k-space lines in the plurality of forward-projected subject image data sets; and
generating the corrected sensitivity maps based on the forward-projected subject image data sets with substituted ACS k-space lines.

8. The method as set forth in claim 6, wherein the MR imaging data set is two-dimensional and no more than five ACS k-space lines are acquired with the two-dimensional MR imaging data set.

9. The method as set forth in claim 2, wherein the correcting comprises iterating the reconstructing and compensating to iteratively improve the corrected sensitivity maps.

10. The method as set forth in claim 1, wherein at least the correcting and the reconstructing are performed by a digital processor.

11. A method comprising:
(i) acquiring sensitivity maps for a plurality of radio frequency coils using a magnetic resonance (MR) pre-scan of a subject;
(ii) acquiring an MR imaging data set for the subject using the plurality of radio frequency coils; and
(iii) reconstructing the MR imaging data set using partially parallel image reconstruction employing the sensitivity maps corrected for subject motion between the acquiring (i) and the acquiring (ii).

12. The method as set forth in claim 11, wherein the reconstructing (iii) comprises:
reconstructing the MR imaging data set using the uncorrected sensitivity maps to generate an initial reconstructed image;
spatially registering the sensitivity maps with the initial reconstructed image; and
repeating the reconstructing using the spatially registered sensitivity maps.

13. The method as set forth in claim 12, wherein the repeating comprises:
moving reconstruction weight matrices based on the spatial registering, the repeating of the reconstructing employing the moved reconstruction weight matrices.

14. The method as set forth in claim 11, wherein the acquiring (ii) comprises acquiring one or more auto-calibration signal (ACS) k-space lines with the MR imaging data set and the reconstructing (iii) employs the ACS k-space lines to correct the sensitivity maps for subject motion.

15. The method as set forth in claim 14, wherein the reconstructing (iii) employs the ACS k-space lines to correct the sensitivity maps for subject motion by:
reconstructing the MR imaging data set using the uncorrected sensitivity maps to generate an uncorrected reconstructed image;
re-projecting the uncorrected reconstructed image adjusted by the uncorrected sensitivity maps to generate a plurality of forward-projected subject image data sets;
substituting the ACS k-space lines in the forward-projected subject image data sets; and
generating corrected sensitivity maps from the forward-projected subject image data sets with substituted ACS k-space lines.

16. A digital storage medium storing instructions executable by a digital processor to reconstruct a magnetic resonance (MR) imaging data set using a method as set forth in claim 1.

17. An apparatus comprising:
a digital processor configured to perform magnetic resonance (MR) imaging in cooperation with an MR scanner using a method comprising:
(i) acquiring sensitivity maps for a plurality of radio frequency coils using an MR pre-scan performed by the MR scanner,
(ii) acquiring an MR imaging data set using the plurality of radio frequency coils and the MR scanner, and
(iii) reconstructing the MR imaging data set using partially parallel image reconstruction employing the sensitivity maps and a correction for subject motion between the acquiring (i) and the acquiring (ii).

18. The magnetic resonance imaging system as set forth in claim 17, comprising:
said magnetic resonance (MR) scanner.

19. The magnetic resonance imaging system as set forth in claim 17, wherein the reconstructing (iii) comprises:
modifying the sensitivity maps based on one or more auto-calibration signal (ACS) k-space lines acquired in the acquiring (ii).

20. The magnetic resonance imaging system as set forth in claim 19, wherein the modifying is based on five or fewer ACS k-space lines acquired in the acquiring (ii).

21. The magnetic resonance imaging system as set forth in claim 17, wherein the reconstructing (iii) comprises:
performing a first partially parallel image reconstruction on the MR imaging data set using the sensitivity maps to generate an initial reconstructed image;
adjusting reconstruction weight matrices based on spatial registration of the initial reconstructed image and a pre-scanned image acquired during acquisition of the initial sensitivity maps; and
performing a second partially parallel image reconstruction on the MR imaging data set using the adjusted reconstruction weight matrices to generate a corrected reconstructed image.
